(19) United States
(12) Patent Application Publication
(10) Pub. No.: US 2015/0183007 A1
(43) Pub. Date: Jul. 2, 2015

(54) WATERLESS AND OTHER METHODS FOR CLEANING UP POWDER OR OTHER CONTAMINANTS

(71) Applicant: Renaissance Service, West Jordan, UT (US)

(72) Inventor: Barney Boynton, West Jordan, UT (US)

(21) Appl. No.: 14/658,745

(22) Filed: Mar. 16, 2015

Related U.S. Application Data
(63) Continuation-in-part of application No. 13/931,557, filed on Jun. 28, 2013.

(51) Int. Cl. B08B 7/04; B08B 5/04; B08B 1/00; B08B 3/04; B08B 3/08

(52) U.S. Cl. CPC B08B 7/04; B08B 3/04; B08B 3/08; B08B 1/002; B08B 5/04

(57) ABSTRACT

Methods are presented for managing a contaminant that may be in a powdered form. One such method can include pre-cleaning a contamination area where a contaminant can be introduced, and constructing a media barrier and blocking an infrastructure feature with the media barrier so that ingress of the contaminant into the infrastructure feature is prevented. The contaminant can be removed from the contamination area by performing a hand sweep of the contamination area, and performing mechanized sweeping of the contamination area. Next residual contaminant in the contamination area is treated, and the treated contaminant allowed to naturally disperse. The media barrier is then removed.

### RELATED APPLICATIONS

The present application is a continuation-in-part (CIP) of, and hereby claims priority to, U.S. patent application Ser. No. 13/931,557, entitled METHOD FOR CLEANING UP POWDER OR OTHER CONTAMINANTS, and filed Jun. 28, 2013. All of the aforementioned applications are incorporated herein in their respective entireties by this reference.

### BACKGROUND

Recently, an event known as a Color Run™ has become popular in the United States and other areas. A Color Run™-style event is a fitness run in which the course includes several “Color Zones.” At each Color Zone, event organizers, employees, or volunteers disseminate a colored powder onto event participants. The colored powder often comprises dyed food-grade corn starch, and colors the event participants' skin and clothing. A Color Run™-style event additionally may include a color festival at the conclusion of the run at which event participants disseminate, frequently by throwing into the air, colored powder provided by event organizers.

When the fun has ended, event organizers must deal with cleanup of the colored powder. Although using water to wash the colored powder down existing storm drains would be a convenient solution, in virtually every municipality or jurisdiction laws or regulations prohibit or severely restrict washing anything except water into storm drains.

Previously, cleanup crews have attempted to clean up the colored powder by using regenerative air street sweepers and then washing residue colored powder into storm drains. However, such methods are unsatisfactory for several reasons: (1) they are labor intensive, (2) they fail to adequately remove the colored powder, and (3) they cause undesirable dissemination, rather than containment, of the colored powder. Additionally, such ineffective methods risk ground water contamination resulting from discharge into storm drains. What is needed is a method for cleanup of Color Run™-style events—or any circumstance involving disseminated powder or other substances—that overcomes and/or mitigates these shortcomings.

### SUMMARY OF ASPECTS OF EXAMPLE EMBODIMENTS

The present invention relates to methods for cleaning and removing powder or other substances which may result from a Color Run™-style event or from other events or circumstances. In one embodiment, a contamination area, i.e., an area where powder or some other substance has been disseminated, is cleaned by plugging one or more storm drains, using water to wash the powder into the storm drain(s), and then relocating the contaminated water from the storm drain(s) into one or more sewer drain(s) or other acceptable location(s). Additional processes may include one or more of, in any combination, pre-cleaning the anticipated contamination area, using a sweeper vacuum to clean up the powder, prewashing the anticipated contamination area, pre-cleaning the storm drain(s), closing access to storm drains that will not be used, pre-treating with a sodium hypochlorite solution, and/or pretreating with a brine solution.

In an additional embodiment, a contamination area is cleaned by using a sweeper machine apparatus equipped with a vacuum system. Additional processes may comprise the additional processes described above, as well as spraying the contamination area with a light mist of a sodium hypochlorite solution when only a light dusting or residue of powder remains. Details regarding embodiments, variations, and additional steps are described below.

Finally, in another example embodiment, a waterless or substantially waterless method is implemented where a series of media barriers are employed to block or otherwise protect features, such as storm drains for example, from the entry of contaminants that have been dispersed in a contamination area.

### BRIEF DESCRIPTION OF THE DRAWINGS

To further clarify the aspects of embodiments of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 depicts an exemplary contamination area that may result from a Color Run™-style event, or from any event or circumstance that may result in dissemination of powder or other substance;

FIG. 2 depicts the processes of one exemplary embodiment of the present invention;

FIGS. 3a-3c disclose various example arrangements of media barriers and an evaporation zone relative to a contamination area and infrastructure features;

FIG. 4 discloses various example media barrier arrangements and placements;

FIG. 5 discloses various example media barrier configurations;

FIG. 6 is a flow diagram disclosing aspects of an example waterless cleanup method; and

FIG. 7 is a flow diagram disclosing aspects of an example cleanup method.

### DETAILED DESCRIPTION OF EXAMPLE EMBODIMENTS

The present invention relates to methods for effectively cleaning and removing powder remaining after Color Run™-style events, or some other substance which has been disseminated over some area as a result of an event or circumstance. In the following discussion, the term “contaminant” refers to powder, colored powder, or any other substance that may be disseminated over an area. The methods of the present invention may improve on currently employed methods by making cleanup less labor-intensive, less expensive, and more effective by removing a greater amount of the dyed corn starch.

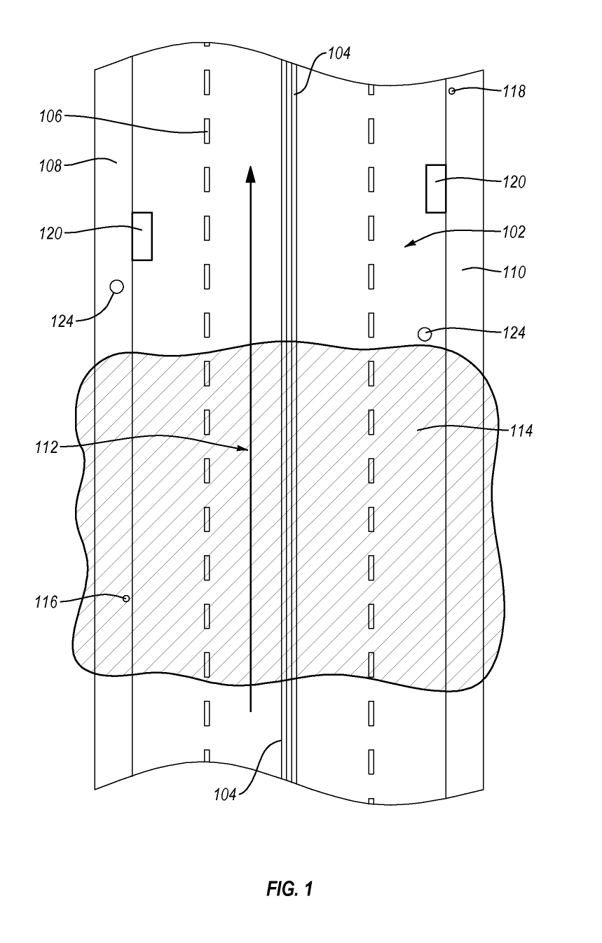

FIG. 1 illustrates an exemplary contamination area 114 along with the area surrounding the contamination area 114. The area depicted in FIG. 1 is exemplary of an area that may result from dissemination of a contaminant. It should be understood that FIG. 1 is merely exemplary, and the invention disclosed herein is applicable to areas of widely varying characteristics.

FIG. 1 depicts a bi-directional street 102, with double-yellow lines 104 separating the two opposite directions of traffic flow, and with dashed lines 106 dividing the lanes for each direction of traffic flow. Sidewalks 108 and 110 represent the sidewalks along the respective sides of street 102. The arrow 112 represents downward slope 112 of street 102. Slope 112 is merely exemplary; the invention disclosed herein applies to widely varying topographies. Contamination area 114 represents an area where contaminant has been disseminated. Water supply(-ies) 116 and 118 illustrate location(s) of one or more exemplary water supply(-ies) such as a fire hydrant or spigot. It is generally irrelevant whether water supply 116 and/or water supply 118 are inside of contamination area 114. Storm drain(s) 120 illustrate exemplary location(s) where one or more storm drains may be located. Sewer drain(s) 124 illustrate location(s) where one or more exemplary sewer drain(s) may be located.

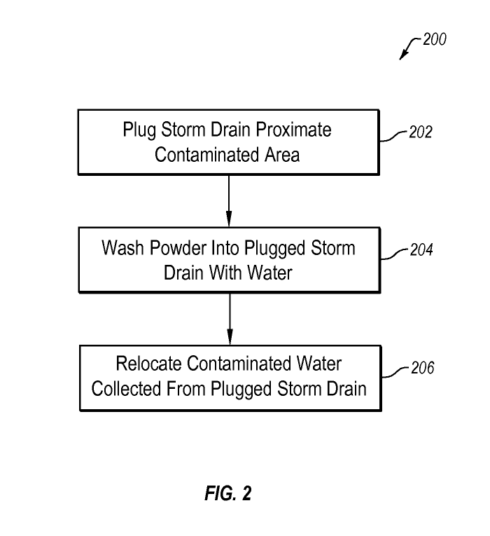

In a first embodiment, and with reference to FIG. 2, a cleanup crew plugs 202 one or more storm drains 120, uses water to wash 204 disseminated contaminant from contamination area 114 into the plugged storm drain(s) 120, and then relocates 206 the resulting contaminated water from the plugged storm drain(s) 120 into a sewer system or other final cleanup location. Access to the sewer system is usually obtained through one or more sewer drains 124.

The cleanup crew strategically selects storm drain(s) 120 to plug by reviewing the contamination area 114 (e.g., the area in and/or around a Color Zone which has been or will be contaminated with colored powder from a Color Run™-style event, or contaminated with some other contaminant), and identifying storm drain(s) 120 into which colored powder will flow when the contamination area 114 is washed with water or receives water from another source, e.g., natural precipitation. Factors affecting identification of storm drain(s) 120 include but are not limited to topography, curbs, fields, sidewalks, and other man-made features.

Additionally, determining which storm drain(s) 120 to plug will be affected by the location of one or more sanitary/sewer drain access(es) 124 which may be used to dispose of contaminated cleanup water collected in plugged storm drain pipes and/or conduit. Proximity to one or more selected sewer drain access(es) 124 increases the convenience of this embodiment as described below.

There are varied methods for plugging storm drain(s) 120. In one exemplary method, one or more flexible expandable waterproof objects are used to plug a circular storm drain pipe or conduit. Such plugs are widely and commonly available as exercise, yoga, or Pilates™ balls or similar items. Such plugs are expandable and contractible, commonly through inflation or deflation with air from a pumping apparatus. Plugs with other means for expanding and/or contracting may also be used. The size of such a plug is selected so that the plug completely fills a storm drain pipe when expanded, but may be moved through a storm drain pipe in when in a deflated or contracted state.

In order to plug the storm drain(s) 120, storm drain pipes or passages are generally accessed by removing a ground-level grate or cover, although the storm drain pipes or conduits may be accessed by any means as appropriate based on the particular setup or design of a storm drain system.

A determination must additionally be made regarding the precise location in the storm drain pipe or conduit to place the plug. In general, this determination is made by analyzing the anticipated contamination zone along with the location(s) of the storm drain(s) 120, and determining how much storm drain pipe/conduit volume (i.e., temporary reservoir volume) is sufficient to store the amount of water that will collect as a result of washing the contamination area 114 or as a result of water or liquids from other sources, e.g., natural precipitation. Placing a plug at a greater distance from a storm drain 120 increases the available volume of storage for contaminated water in a particular storm drain pipe or conduit. Plugs may be secured and tethered to prevent undesired movement from forces such as static pressure.

When the selected storm drain(s) 120 have been plugged, water is used to wash the contaminant into the one or more plugged storm drain(s) 120. Water may be conveniently obtained from one or more water supplies 116. A water supply 116 may comprise a fire hydrant, an outdoor or indoor water spigot, a water truck, or any other water source. A water meter may be attached to a selected fire hydrant or other water source 116, and hoses may be connected to a fire hydrant or other water source 116 through the water meter. Washing the contaminant into or toward the selected storm drain(s) 120 is accomplished by generally known methods of using water from a hose or other apparatus to wash debris, in this case contaminant, in a desired direction, e.g., into one or more storm drain(s) 120.

When the contaminant has been washed into the one or more plugged storm drain(s) 120, the contaminated water in the plugged storm drain(s) 120 is relocated into the one or more selected sewer/sanitary drain access(es) 124. This relocation may be accomplished in several ways.

In one preferred embodiment, a pump is used to relocate the contaminated water from a plugged storm drain 120 into a sewer/sanitary drain 124 or into any other acceptable disposal system. Many varieties of pumps are generally available. In one preferred embodiment, the pumping apparatus has at least two hoses, one for intaking the contaminated water from the one or more plugged storm drains, and one for expelling the contaminated water from the hose into the sewer/sanitary drain access. Exemplary pumping systems include but are not limited to self-priming submersible pumps and contractor pumps. A person of ordinary skill will recognize that many types of pumping systems or apparatuses may be used to relocate the contaminated water from one or more plugged storm drain(s) 120 into one or more sewer/sanitary drain(s) 124. Of course, relocating the water may be accomplished with means other than a pumping system, such as by using buckets or Shop-Vacs to place the contaminated water in a container or bucket and then relocating (by carrying or any other means) the container or bucket to a sewer/sanitary drain access 124 and discharging the contents of the container/bucket into sewer/sanitary drain 124.

Several optional processes may improve and/or enhance the methods disclosed herein. Such optional processes include but are not limited to a pre-cleaning process and a sweeper process.

One optional process comprises a pre-clean prior to dissemination of contaminant in the contamination area. The pre-clean promotes more efficient cleanup by removing debris that may collect contaminant or detract from the cleanup steps described herein. Several techniques may be used to accomplish a pre-clean. One pre-clean process comprises using specialized sweeping equipment to capture and dispose of foreign material, e.g., dirt, leaves, garbage, sticks, in an anticipated contamination area 114. Another pre-clean step comprises a prewash/rinse into a storm drain system or into any other acceptable discharge system. Such a prewash may be accomplished using water from a fire hydrant, water truck, or other water source using generally known techniques of using water to wash debris and contaminants off of the ground of an anticipated contamination area 114.

Another optional pre-cleaning process comprises pre-cleaning the storm drain(s) 120 in the areas where plugs will be installed. Pre-cleaning the storm drain(s) may be accomplished by removing debris/foreign objects where a plug will be installed, especially the area between a storm drain access 120 and the location in the storm drain system where a plug is to be installed. Conducting such a pre-cleaning of a storm drain 120 helps to ensure that a plug optimally and/or completely seals a storm drain 120 and/or conduit.

Another optional pre-cleanup step comprises closing access to storm drain system accesses that will not be part of the plug system. Determining which storm drains to close off may comprise identifying storm drain accesses in the vicinity of the contamination area which do not need to be or will not be plugged, and which may receive some contaminated water during cleanup.

An additional optional pre-treatment step comprises treating an anticipated contamination area 114 with a sodium hypochlorite solution or a similar substance. This pretreatment may inhibit powder or other substance from sticking to the asphalt and/or concrete (and other surfaces) in an anticipated contamination area 114. The sodium hypochlorite solution may comprise a range of chemical to water ratios, depending on the circumstances. One possibility is to mix an approximately 10-15% sodium hypochlorite solution with water in a ratio of approximate 100-200 parts water to 1 part 10-15% sodium hypochlorite. These ratios and dilution percentages are only approximations; other ratios and dilution percentages are possible depending on the characteristics of the area where the solution is to be applied and possibly also depending on the characteristics of the contaminant.

An additional optional pre-treatment step comprises treating an anticipated contamination area 114 with a proprietary brine solution, which is applied to the ground/surface area of an anticipated contamination area 114 in an amount sufficient to coat the ground surface and then evaporate. The remaining brine residue bonds with the powder or other substance, increasing the effectiveness of a sweeping cleanup. The brine solution may comprise salt dissolved in water. For example, many feed stores sell livestock salt supplement with trace minerals and selenium. This or another salt substance may be dissolved in water to make a brine solution. An exemplary brine solution may comprise approximately 1 lb. of salt for every 4-10 gallons of water. This ration is exemplary and other ratios will also work depending on the specific characteristics of location, weather, contaminant, and other factors.

In an additional embodiment, cleanup begins (after preparing the contamination area 114, pretreating/pre-cleaning, plugging drains, etc., as described herein above) by using a sweeper machine apparatus that is equipped with a vacuum system. The vacuum system may additionally comprise a filter system. Exemplary machines include the Tenent™ and Advance™ brand three-wheeled ride-on sweepers with dust control and vacuum containers. Other similarly functioning machines may also be employed to sweep and/or vacuum a contamination area 114. Use of a combination sweeping and vacuum system provides the benefit of cleaning most (if virtually not all) of the dyed corn starch up, powder, or other substance prior to a more thorough cleanup step. While sweeping without a vacuum system may provide some benefit, such benefit may be undermined by the sweeper's tendency to spread powder into the air, thereby undoing cleanup progress. Using a sweeper combined with a vacuum system removes most, if not virtually all, of the residue powder or other substance before a follow-on cleanup step. Depending on the unique circumstances of each cleanup situation, use of a sweeper/vacuum system may completely obviate the need for some or all additional cleanup steps. Even if some water cleanup is still necessary after use of the sweeper/vacuum, the amount of water is generally significantly decreased and minimized such that a water cleanup step may be performed in significantly less time and with significantly less water than if no sweeper/vacuum system had been employed.

Another optional cleanup step comprises spraying contamination area 114 with a light mist of sodium hypochlorite solution when only a light dusting or residue of contaminant remains. Applying sodium hypochlorite solution to contamination area 114 may be accomplished through the use of tools or devices such as backpack pump sprayers, downstream solution applicators, and pre-mixed solution in a water trailer/truck equipped with a spraying/misting apparatus. Applying sodium hypochlorite solution to colored contaminant, including dyed corn starch residue, has the effect of bleaching the contaminant. The sodium hypochlorite solution may comprise a range of chemical to water ratios, depending on the circumstances. One possibility is to mix an approximately 10-15% sodium hypochlorite solution with water in a ratio of approximate 100-200 parts water to 1 part 10-15% sodium hypochlorite. These ratios and dilution percentages are only approximations; other ratios and dilution percentages are possible depending on the characteristics of the area where the solution is to be applied and possibly also depending on the characteristics of the contaminant.

Because corn starch is a natural and non-toxic product, after it is bleached it will be dispersed through natural wind currents or air flow, usually within minutes or hours at most. Therefore, many cleanups may be completed by simply applying a light mist of sodium hypochlorite to remaining residue of colored powder in contamination area 114. The step of applying sodium hypochlorite solution may be applied whether or not a water cleanup step is employed. If a water cleanup step is employed, sodium hypochlorite solution may be employed after the water has dried/evaporated if there remains any contaminant, e.g., colored powder such as dyed corn starch, in contamination area 114. In most cases, application of sodium hypochlorite solution will not be necessary if a water cleanup step is employed. Often, after performing a sweeper/vacuum step, application of sodium hypochlorite solution will be sufficient to complete cleanup of contamination area 114.

As described above, if a water cleanup step is employed, then it is also necessary to plug storm drain(s) 120, wash the colored powder into the plugged storm drains, and pump or relocate the contaminated cleanup water from plugged storm drains 120 into a sewer/sanitary drain system access 124. Other described steps may be employed as appropriate and described herein.

In some circumstances, water cleanup using sewer drains may be unnecessary. A determination that sewer-drain-water-cleanup is unnecessary may be based on one or more factors such as the predicted efficacy of non-water cleanup methods (as described herein), and a sufficiently minimal likelihood of rain, precipitation, or water from other sources. Upon a determination that water cleanup is unnecessary, it is not necessary to plug drains, relocate water, close access to storm drain accesses, or perform other steps that are specific to water cleanup. When no water is used (and is not present as a result of rain or other outside sources), cleanup may be accomplished by optionally pre-treating contamination area 114 with the brine solution, using the sweeper/vacuum and, and then applying sodium hypochlorite solution to the residue after the sweeper/vacuum step. If necessary, multiple iterations of any of the steps disclosed herein may be performed.

Other embodiments or variants of the steps described herein may also be applied. For example, it may be necessary to obtain licenses or similar approvals from local or governing authorities to use storm drain systems, sewer/sanitary drain systems, water supplies, or other aspects of this invention.

Some storm drain systems are constructed of pipe or conduit that is not circular or substantially circular in shape. In such circumstances, the pipes/conduit may be plugged by using custom constructed plugs where needed. Custom plugs may comprise combinations of other plugs or any other object that is capable of plugging pipe or conduit.

Additionally, a disseminated contaminant may comprise substances and coloring agents other than dyed food-grade corn starch. The methods and steps disclosed herein may be employed analogously to other variants of contaminants such as powders, colored powders, other substances, and/or coloring agents.

The steps and methods disclosed here may be altered and/or modified to account for rainfall or other precipitation. When a weather forecast calls for rain, storm drain systems may be plugged as described herein. In general, any modestly sized pump, e.g., a pump with a two-inch discharge line, is sufficient to relocate contaminated water from a temporary storm drain reservoir into a sewer system at the rate that potentially contaminated rainwater enters a temporary storm drain reservoir. In the event of a pump failure, generator failure, or the event of a 1000-year storm event, the storm drain plugs may be equipped with above grade tethers for fast removal of the plug without entry into a storm drain access.

The methods and steps disclosed herein are not limited to Color Run™-style events, but may be employed in other cleanup circumstances where it is desirable to cleanup a disseminated contaminant. Exemplary circumstances may include substance spills, vehicle crashes with fluid spills, and hazardous waste containment such as gas, oil, hydraulic fluid, pesticide, etc. Additionally, the brine-solution pre-treatment disclosed herein could be applied as a pretreatment under varied circumstances.

Although the disclosure herein frequently references “Color Run™-style events,” a person of ordinary skill will appreciate that the methods disclosed herein apply to any situation requiring cleanup of a disseminated contaminant.

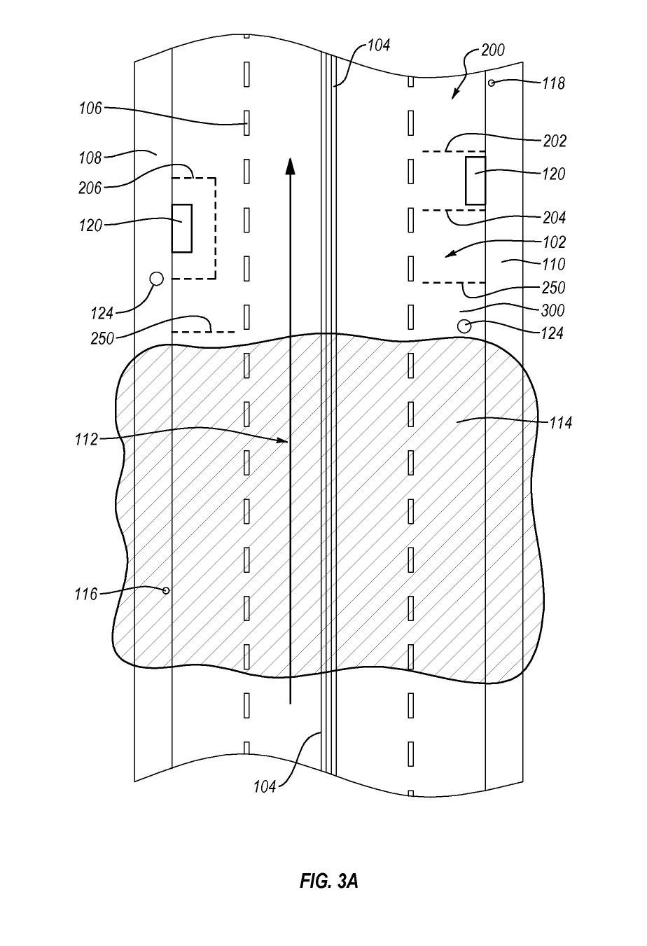

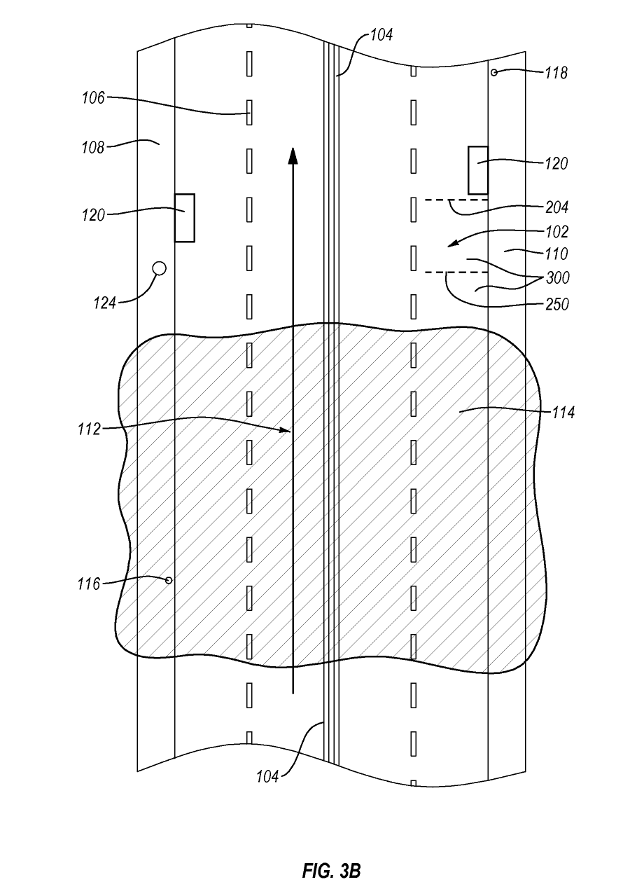

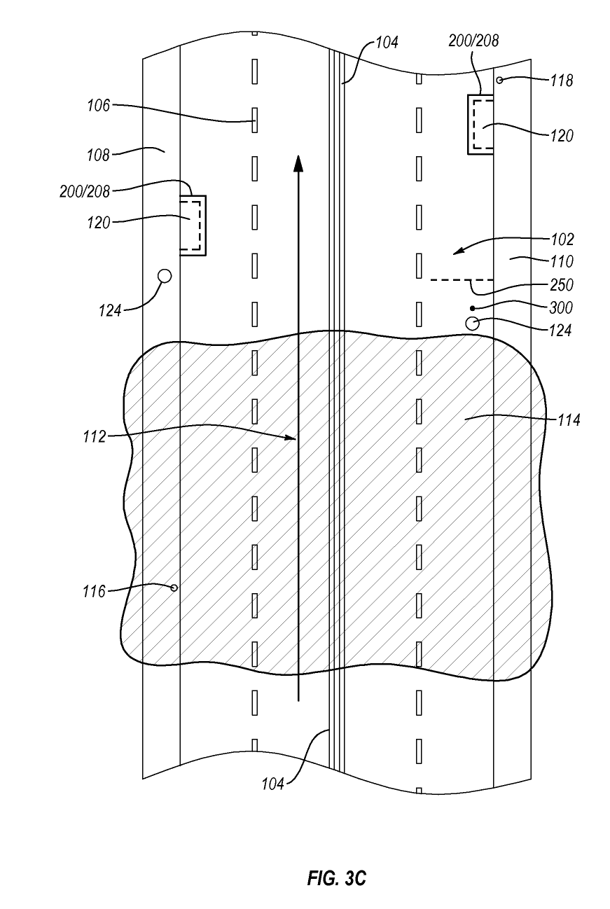

Directing attention now to FIGS. 3a-3c, details are provided concerning aspects of further example embodiments of the invention. In general, the nature of such embodiments is such that they involve little, or no, water usage for the portions of the method involving the collection and disposal of the dispersed contaminant(s) that is/are to be cleaned up, though other elements of these methods may, but need not, involve the use of water. Of course, naturally occurring water, such as rainwater, can affect the manner in which certain of the disclosed methods are carried out. Moreover, some of the waterless methods may involve the use of a water mist for dispersal of an oxidizing agent.

Because a variety of environmental and infrastructure considerations can be involved in any particular situation, it will be appreciated that any one or more steps, acts and/or elements of the waterless methods disclosed herein can be used in combination with any one or more steps, acts and/or elements of the water based methods disclosed elsewhere herein. As such, the scope of the invention is not limited to the disclosed embodiments, which are presented simply by way of example.

With particular reference now to FIGS. 3a, 3b and 3c, some example embodiments employ a containment approach with respect to drains such as storm drains 120, although the containment approach can generally be extended to any other natural and/or infrastructure feature that is desired to be kept free of contamination by one or more dispersed contaminants. Examples of such features that can be protected with a containment approach include, in addition to storm drains, sewer drains, gutters, irrigation ditches, canals, creeks, rivers, lakes, and oceans. In general, this containment approach seeks to prevent some, or all, dispersed contaminant(s) from ever reaching features such as the storm drain 120, and can thus eliminate the need to plug the storm drains 120 and/or the need perform comparable processes with respect to other infrastructure and/or natural features.

As shown in FIG. 3a, containment with respect to a storm drain 120, for example, can be effected with a variety of different media barriers 200, examples of which are denoted at 202, 204 and 206. A given application may include only one type of media barrier, or multiple types of media barriers. In the example of FIG. 3a, media barriers 202 and 204 are disposed on the street or road on either side of a storm drain 120. In yet other cases however, only media barrier 204, located between the storm drain 120 and the contamination area 114, is present.

When employed in connection with events involving the dispersal of contaminants, media barriers 200 can be employed in a variety of different areas. For example, when used in connection with a ColorRun® for example, media barriers can be placed in one or more of the color zones, start chute, finish chute, and festival area, and/or any other areas where contaminants are likely to be dispersed.

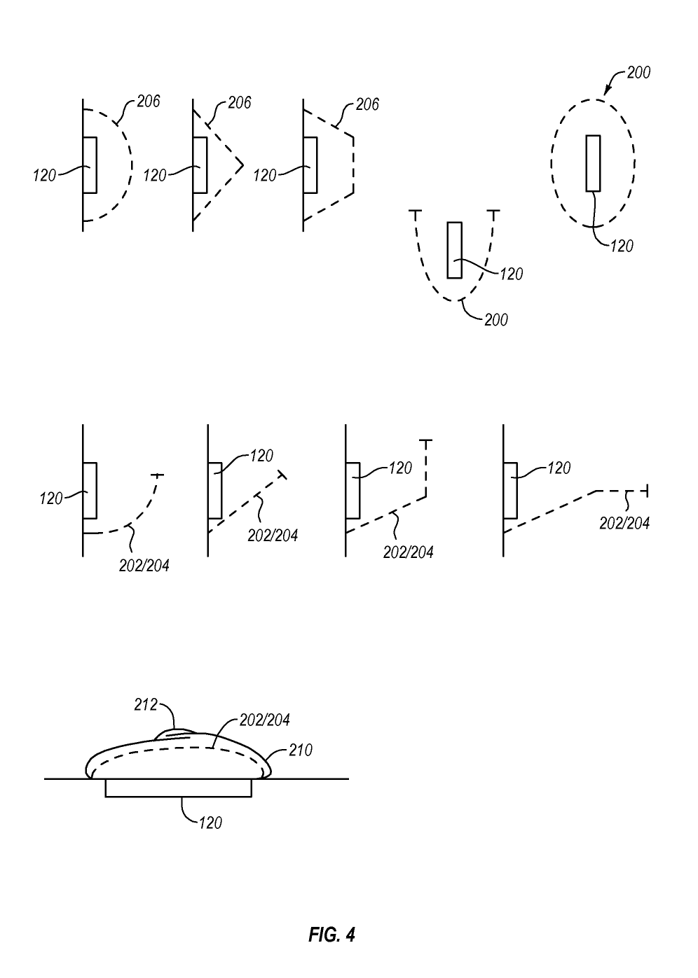

The media barriers 200 can have any suitable configuration. In the example of FIG. 3a, the media barriers 202 and 204 are generally linear in shape, while the media barrier 206 is generally rectangular in shape. Of course, any other suitable configurations could be employed. By way of example, and with reference now to FIG. 4, media barrier 206 could alternatively be in the shape of a semicircle, a triangle, or a portion of a polygon, or any other shape that serves to close off the storm drain 120 and/or other feature(s) from the contamination area 114. In similar fashion, the media barriers 202 and 204 can be curved or angled, or any other suitable shape that blocks the storm drain 120 and/or other features from the contamination area 114. As best shown in FIG. 3a, and with continuing reference to FIG. 4, infrastructure elements such as curbs, gutters and sidewalks for example, can cooperate with one or more media barriers to isolate a storm drain 120 or other feature. Where such infrastructure elements are not present or usable however, one or more media barriers 200 can be employed that partly isolate, or surround, the feature(s) desired to be protected from contamination, as disclosed in FIG. 4.

In yet other embodiments, and as shown in FIGS. 3c, 4 and 5, the media barriers 200 can be placed on top of a storm drain 120 or other feature so as to cover the storm drain 120 entrance and thus block entry into the storm drain 120 of any contaminants. In still other embodiments, media barriers 200 can be placed both on top of, and around, features such as a storm drain 102, as indicated in FIG. 3c for example.

In general, the size, shape, and orientation of the media barriers 200, and evaporation containment barriers 250 discussed below, can be implemented as necessary to suit particular conditions and circumstances, and the scope of the invention is not limited to the examples disclosed herein.

With continued reference to FIGS. 3a and 4, and directing attention as well to FIG. 3b and FIG. 3c, some embodiments can employ one or more evaporation containment barriers 250 that are used in conjunction with one or more media barriers 200 to create one or more evaporation zones 300. The evaporation containment barriers 250 can help to contain, in the evaporation zone 300, contaminants that are entrained in fluid from reaching storm drains 120 or other features. Where the contaminants are food grade materials such as corn starch, or other harmless materials, the fluid in the evaporation zone 300 can be allowed to evaporate and any remaining contaminants treated, such as with an oxidizer, or simply be allowed to be dissipate naturally such as by wind action. Any fluid that does not evaporate from the evaporation zone 300 can be removed along with any remaining contaminant(s).

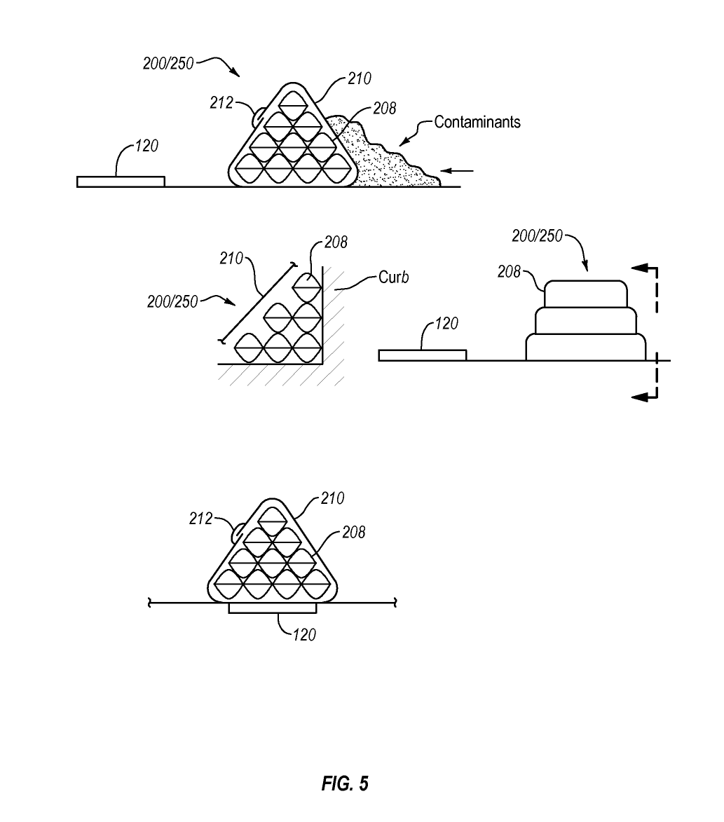

The media barriers 200 and evaporation containment barriers 300 can be constructed in any of a variety of different ways consistent with their purpose to prevent the ingress of contaminants to the storm drain 120 and/or other protected features. Directing attention now to FIG. 5, and with continuing attention to FIGS. 3a, 3b and 4, some example media barrier 200 constructions are disclosed. While the following discussion is directed to media barriers 200, the discussion applies equally to evaporation containment barriers 300 as well.

In one example embodiment, the media barrier 200 can include a baffle arrangement formed by stacking any number of sandbags 208, or any other items that are relatively heavy but have a shape that can conform to the shape of adjacent elements, such as the street for example. The sandbags 208 can be stacked in any manner that serves the containment function. In this particular example, shown in cross-section, a 4-3-2-1 arrangement is employed where the bottom of the media barrier 200 is formed by a row of 4 sandbags 208, the next row has 3 sandbags 208, the next row has 2 sandbags 208, and then a single sandbag is provided at the top 208. Of course, more, or fewer, sandbags 208 can be employed in a similar triangular configuration, or in any other suitable configuration. For example, an offset configuration, as shown in FIG. 5, similar to that used with bricks of a wall, could alternatively be employed. As another example, a 3-2-1 configuration could also be used.

Although not required, any of the disclosed embodiments of the media barrier 200 and evaporation containment barrier 250, including those shown in FIG. 5, can also include a fluid barrier 210, such that a multi-stage barrier is provided. One example of a fluid barrier 210 is low density polyethylene (LDPE) sheeting sold under the name VISQUEEN®. Any other suitable fluid barrier material can alternatively be employed. The fluid barrier 210 can completely enclose the sandbags 208 so that no portion of the sandbags is exposed. Thus, the fluid barrier 210, which may have one or multiple layers, can provide an additional measure of contaminant for the media barrier 200, and can also help prevent particulates from working into any spaces between the sandbags 208. If desired, the ends of the fluid barrier 210 can be secured together with tape 212, such as duct tape for example, or any other suitable mechanism.

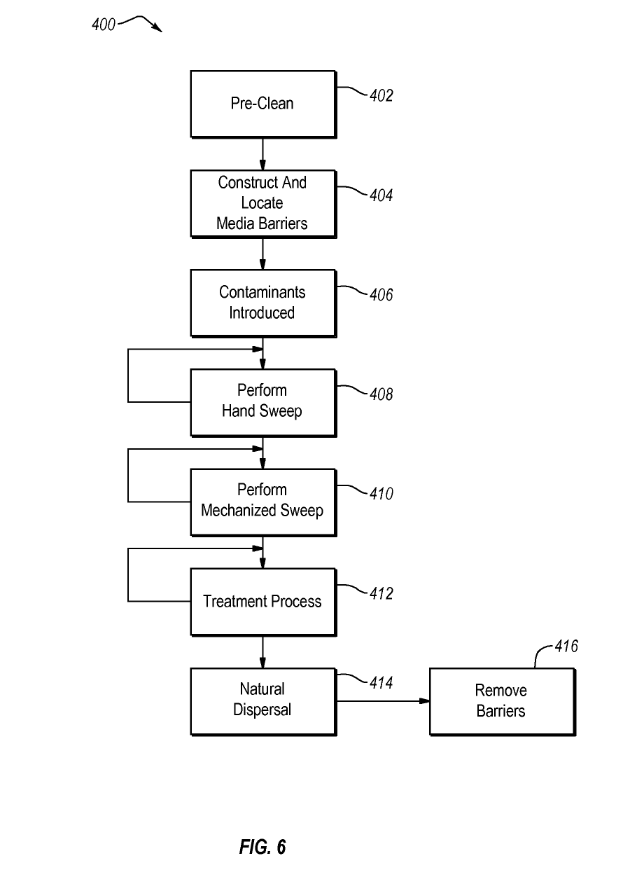

Turning now to FIG. 6, details are provided concerning an example method for waterless cleanup of a dispersed contaminant, denoted generally at 400. Initially, a pre-cleaning process 402 is performed. The pre-cleaning process 402 can be performed in one or more areas where contamination is planned, or expected. For example, where a ColorRun® is to take place, one or more of the color zones, start chute, finish chute and festival area may all be pre-cleaned 402. In at least some instances, the pre-cleaning process 402 includes hand sweeping the aforementioned and/or other areas of a road or street. The pre-cleaning 402 can also include removal of large debris, rocks and any other items that could impair usage of the area where those items are present. While it may be performed as a waterless process, the pre-cleaning 402 may, in some embodiments, include the use of water to wash streets or roads so as to clear accumulated dirt, debris, rocks and/or other materials. If used, the water, can be applied in any of the various manners disclosed herein.

After the pre-cleaning process is performed 402, the method 400 advances and one or more media barriers are constructed and located 404. In at least some embodiments, the media barriers are placed so as to isolate storm drains and/or other features within one or more designated areas. The designated areas can be in, and/or near, a contamination zone, and may include, for example, color zones, a start chute, a finish chute and a festival area. Such isolation can be provided, for example, by using media barriers to cover the entry to one or more storm drains and/or other features desired to be isolated from contaminants, and/or by disposing media barriers around then entrance to one or more storm drains and/or other features desired to be isolated from contaminants. In some instances, construction and location 404 of media barriers can include plugging storm drains and/or other features, for example, as disclosed elsewhere herein.

Once the media barriers are constructed and located, contaminants can be introduced 406 into one or more contamination zones. In the case of sporting events such as those disclosed herein, the introduction 406 of contaminants may be intentional and anticipated, however the scope of the invention is not limited to such circumstances.

In fact, embodiments of the invention can be employed in circumstances where contaminants are anticipated to be introduced accidentally, intentionally and/or as a result of an act of nature. Moreover, embodiments of the invention can be employed where contamination has already occurred and entered into one or more features such as drains or bodies of water, but where it is desired to limit or prevent further contaminants from entering features such as a storm drain, sewer drain, or natural features such as bodies of water.

In any event, after contaminants have been introduced 406 into one or more contamination areas, a hand sweep process and collection process 408 can be performed in the contamination area(s). If desired, the hand sweep and collection process 408 can be performed multiple times. In general, the contaminant(s) that are collected in this process can be disposed in any suitable container(s) that can then be removed from the premises. In some embodiments, a further mechanized sweep process 410 can be performed to collect as much remaining contaminant as possible from the contamination area(s). If desired, the mechanized sweep process 410 can be performed multiple times. The mechanized sweep process 410 can be performed with any suitable equipment including, but not limited to, a ride-on, self-contained vacuum sweeper. A vacuum truck or regenerative air sweeper can additionally, or alternatively, be used as part of the mechanized sweep process 410, although in at least some circumstances, these devices may not perform as well as the ride-on, self-contained vacuum sweeper. As part of the mechanized sweep process 410, the contaminants collected can then be disposed of.

After completion of the mechanized sweep process 410, little or no contaminants may be present in the contamination areas. Where a colored residue remains in one or more contamination areas, a treatment process 412 can be performed. In at least some embodiments, the treatment process 412 can include wet, such as with a water mist, or dry, dispersal of a treatment material, such as an oxidizing agent as disclosed herein. In general, the oxidizing agent can neutralize some or all of the color of any remaining residue such that such residue is less visually apparent, thereby improving the aesthetics of the contamination zone(s). Advantageously, the treatment process 412 can eliminate any need to pressure wash, or otherwise clean, the contamination areas, and thus avoids the discharge of contaminants to drains and other infrastructure and/or natural features.

After the treatment process 412 is completed, any remaining treated contaminant(s) can be dispersed naturally 414, such as by wind, rain and/or other natural phenomena. Additionally, or alternatively, any remaining contaminants can be dispersed with mechanized devices, such as leaf blowers for example. Finally, at 416, any media barriers, evaporation containment barriers, and/or plugs can be removed. If desired, the process 416 can be performed prior to the process 414, and also prior to process 412 if desired.

It should be noted with respect to the method 400, the various processes disclosed can be performed in any desired order. Moreover, and as indicated in FIG. 6, any one or more of the individual processes, such as 408, 410 and/or 412 for example, of the method 400 can be performed multiple times. Accordingly, the scope of the invention is not limited solely to the disclosed method 400.

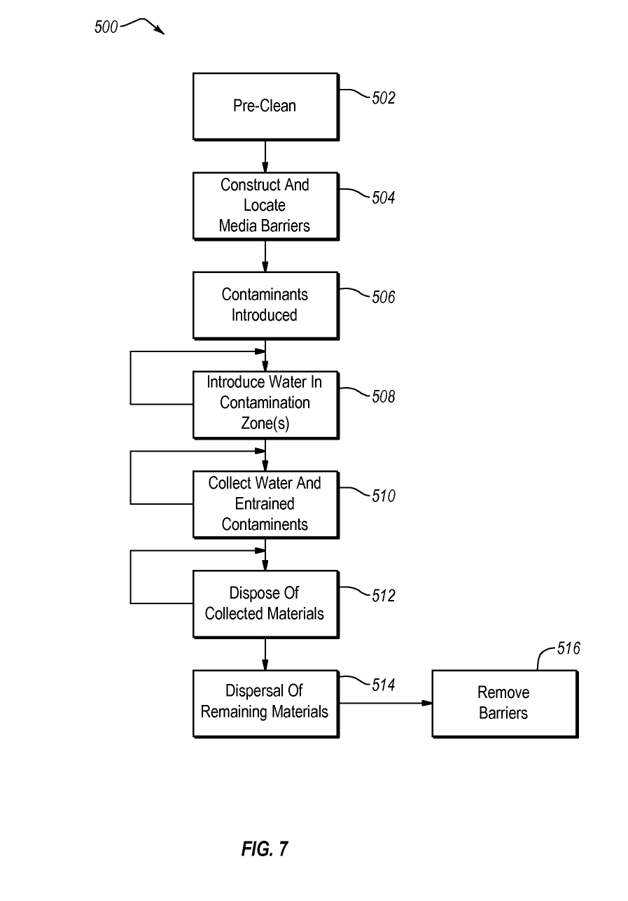

Turning now to FIG. 7, and as noted earlier herein, a method 500 is disclosed that includes elements of waterless cleanup methods combined with various processes involving the use of water. The method 500 can be used, for example, where water is desired to be used for clean-up and/or where naturally occurring water such as rainfall is expected.

In general, pre-cleaning 502, and construction and location 504 of media barriers, evaporation containment barriers, and plugs, can be performed similarly, or identically, to the pre-cleaning and construction and location processes respectively discussed, for example, in connection with FIG. 6 and also in connection with FIGS. 1 and 2. After these initial processes, contaminant(s) can be introduced 506, as discussed in more detail in connection with FIG. 6.

To clean up the dispersed contaminants, the process 500 advances to 508 where water is introduced, by spraying with hoses for example, into the contamination zone(s). The water can be introduced 508 by any suitable device or mechanism. In some embodiments, the water is introduced 508 with a vacuum truck, such as are employed by septic tank and sewer cleaning companies for example. As the water mixes with the contaminant(s), the water becomes colored with the contaminant(s) if they are colored. In some instances, a treatment agent, such as an oxidizing agent for example, can be mixed with the water prior to introduction 508 so that the collected water, and/or any residual water in or near the contamination zone(s) and/or evaporation zones, may be lightly colored, or completely colorless.

The water and entrained contaminant(s) can then be collected 510 by any suitable collection device or mechanism, one example of which is a vacuum truck. One particular vacuum truck may have a storage capacity of about 3200 gallons, and can remove about 100 gallons per minute of fluid, although vacuum trucks and collection devices of other capabilities can also be employed. As part of, or subsequent to, the collection process 510, water and entrained contaminants can be collected from one or more evaporation zones.

In some example embodiments, the collection device or mechanism used to collect the water and entrained contaminant can be a vacuum truck positioned to take advantage of the grade of the road or other location where the contamination zone exists. For example, in the case of a storm drain located in a sloping portion of a road, the collection device can be placed upstream of the storm drain but downstream of the contamination zone, so as to intercept the water and entrained contaminants leaving the contamination zone before they arrive at the storm drain. As will be appreciated from this example, the contamination zones can be strategically defined and located so as to enable collection of fluid and entrained contaminants as just described. Moreover, locating the collection device or mechanism(s) in this way can help to avoid the need for open landscape diversion of the water and entrained contaminant(s).

Once the fluid and entrained contaminant(s) have been collected 510, the collected materials can then be disposed of 512. Dispersal 514 of any remaining contaminants can be performed as disclosed in the discussion of FIG. 6. Finally, at 516, any media barriers, evaporation containment barriers, and/or plugs can be removed. If desired, the process 516 can be performed prior to the process 514, and also prior to process 512 if desired.

What is claimed is:

1. A method for managing a contaminant, comprising:
pre-cleaning a contamination area where a contaminant can be introduced;
constructing a media barrier and blocking an infrastructure feature with the media barrier so that ingress of the contaminant into the infrastructure feature is prevented;
removing contaminant from the contamination area by performing a hand sweep of the contamination area;
performing mechanized sweeping of the contamination area;
treating any residual contaminant in the contamination area;
allowing treated contaminant to naturally disperse; and
removing the media barrier.

2. The method as recited in claim 1, wherein the contaminant is in the form of a colored powder.

3. The method as recited in claim 1, wherein the contaminant comprises corn starch.

4. The method as recited in claim 1, wherein the infrastructure feature comprises one of a storm drain, or a sewer drain.

5. The method as recited in claim 1, wherein constructing a media barrier comprises stacking a plurality of sandbags and covering the stack of sandbags with a fluid barrier.

6. The method as recited in claim 5, wherein blocking an infrastructure feature with the media barrier comprises covering the infrastructure feature with the fluid barrier, stacking the sandbags on the fluid barrier, and wrapping the sandbags with the fluid barrier.

7. The method as recited in claim 1, wherein constructing a media barrier comprises stacking a plurality of sandbags on a fluid barrier upstream of the infrastructure feature and covering the stack of sandbags with the fluid barrier, wherein the sandbags are arranged in a baffle configuration.

8. The method as recited in claim 1, wherein performing mechanized sweeping comprises sweeping with a ride-on, self-contained vacuum sweeper.

9. The method as recited in claim 1, wherein treating any residual contaminant in the contamination area comprises treating the residual contaminant with an oxidizing agent.

10. The method as recited in claim 1, wherein the method is performed without the use of artificially introduced water, except for the treatment of any residual contaminant.

11. A method for managing a contaminant, comprising:
pre-cleaning a contamination area where a contaminant can be introduced;
constructing a media barrier and blocking an infrastructure feature with the media barrier so that ingress of the contaminant into the infrastructure feature is prevented;
constructing an evaporation containment barrier upstream of the infrastructure feature so as to define an evaporation zone;
removing contaminant from the contamination area by introducing water into the contamination area;
collecting water and entrained contaminant from the contamination area;
treating any residual contaminant in the contamination area;
allowing treated contaminant to naturally disperse; and
removing the media barrier and the evaporation containment barrier.

12. The method as recited in claim 11, wherein collecting water and entrained contaminant comprises vacuuming the water and entrained contaminant.

13. The method as recited in claim 11, wherein the infrastructure feature comprises one of a storm drain, or a sewer drain.

14. The method as recited in claim 11, wherein constructing a media barrier comprises stacking a plurality of sandbags on a fluid barrier, and covering the stack of sandbags with the fluid barrier.

15. The method as recited in claim 14, wherein blocking an infrastructure feature with the media barrier comprises covering the infrastructure feature with the fluid barrier, stacking the sandbags on the fluid barrier, and wrapping the sandbags with the fluid barrier.

16. The method as recited in claim 14, wherein the sandbags of the media barrier are arranged in a baffle configuration.

17. The method as recited in claim 11, wherein constructing an evaporation containment barrier comprises placing a fluid barrier upstream of the infrastructure feature and the media barrier, stacking a plurality of sandbags on the fluid barrier, and covering the stack of sandbags with the fluid barrier.

18. The method as recited in claim 11, further comprising allowing water in the evaporation zone to evaporate naturally.

19. The method as recited in claim 11, wherein collection of water and entrained contaminant from the contamination area is performed upstream of the infrastructure feature.

20. The method as recited in claim 11, wherein treating any residual contaminant in the contamination area comprises spraying an oxidizing agent, entrained in water, on the residual contaminant.
